(19) United States
(12) Patent Application Publication
(10) Pub. No.: US 2005/0279213 A1
(43) Pub. Date: Dec. 22, 2005

(54) Method and apparatus for controlling the operation of a dust collector

(76) Inventor: John E. Otto, Geneva, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/152,885

(22) Filed: Jun. 15, 2005

Related U.S. Application Data
(60) Provisional application No. 60/581,299, filed on Jun. 18, 2004.

(51) Int. Cl. B01D 46/46

(52) U.S. Cl. 96/397; 96/424; 96/417

(57) ABSTRACT

A method and apparatus for controlling the operation of a dust collector are provided. The method and apparatus include a remote control for controlling at least one of the speed and time of operation for a dust collector. The remote control includes a transmitter for transmitting signals for controlling the dust collector and a receiver for receiving the signals transmitted from the transmitter and controlling the dust collector accordingly.

### CROSS-REFERENCE TO RELATED APPLICATION

This application claims benefit of U.S. Provisional Application No. 60/581,299, filed Jun. 18, 2004, which is hereby incorporated herein by reference in its entirety.

### FIELD OF THE INVENTION

The present invention is directed to an apparatus for controlling the operation of a dust collector and, more particularly, to a remote control for operating the dust collector.

### BACKGROUND OF THE INVENTION

Woodworking generally creates a large amount of dust in a workshop environment, particularly through the cutting, lathing, sanding, grinding, or planing of wood using power tools or machines. In order to remove this dust, most workshops employ vacuum systems, such as dust collectors, to remove the dust particles from the workshop environment. In fact, in larger workshops, several tools may be connected to the dust collector via a network of hoses which operate to draw dust particles away from the tools being operated and out of the air of the workshop.

One shortcoming with such dust collectors, however, is the need to walk from the power tool to the dust collector to turn the dust collector on and off. This is even more noticeable in larger workshops where multiple tools are connected to one dust collector and the dust collector is placed far away from the tools in order to reduce the noise present in the workshop during its operation. To solve this problem, some companies have started offering after market remote controls which typically consist of small housings containing a receiver, a power cord for connecting the remote control to a power outlet, and an electrical socket for receiving the power cord of the dust collector. The remote control unit is placed on the floor near the dust collector with the dust collector's power cord plugged into the remote control's electrical socket and the remote control's power cord plugged into the wall outlet for power. With such a unit, an operator can turn on and off the dust collector from a transmitter that he or she keeps near.

Although these after market remote controls allow the operator to turn on and off the dust collector from a remote location, they often clutter up the floor of the workshop and add to the amount of equipment that must be moved when a dust collector is relocated or put away. This is of particular concern in smaller workshops where floor space is at a premium and tools and dust collectors are regularly moved to make room for other tools or stored away when not in use. Similarly, existing after market remote controls hinder the mobility of dust collectors by tethering them to the remote control unit on the floor.

Another shortcoming with existing remote control units is that they are often difficult to operate via the transmitter due to the proximity of the receiver to the workshop floor and obstructions formed by other workshop equipment and furniture. For example, work benches and other tools often obstruct the path between the transmitter and the receiver thereby causing the operator to walk over to the dust collector in order to turn it on and off. The inability to conveniently turn the dust collector on and off may thus result in the dust collector being left on for unnecessarily long periods of time; thus, making for an inefficient use of electricity and adding needlessly to the noise of the workshop environment. This is even more noticeable in workshops where the dust collector has been placed in a separate room or closet to reduce the noise present in the workshop during its operation. In such environments, the transmitter signal is often incapable of passing through an obstruction, such as a wall or door, and requires the operator to walk from the power tool to the dust collector each time the dust collector is to be turned on or off.

Yet another shortcoming with existing remote control units is that they do not provide operators with anything but the ability to turn on and off the dust collector remotely. For example, existing dust collectors do not account for whether or not multiple tools are connected to the dust collector and are being operated at the same time. Existing remote controls also do not allow the operator to program the dust collector to operate in a desired manner.

Accordingly, it has been determined that the need exists for a remote control for a dust collector which overcomes the aforementioned limitations and further provides capabilities, features and functions, not available in current remote control units.

### BRIEF DESCRIPTION OF THE DRAWINGS

FIG. 1 is a perspective view of a remote control embodying features of the present invention;

FIG. 2 is schematic drawing of the receiver of FIG. 1;

FIG. 3 is a schematic drawing of the transmitter of FIG. 1;

FIG. 4 is a perspective view of a dust collector having the receiver of FIG. 1 mounted thereto;

FIG. 5 is a perspective view of an alternate dust collector having an integrated receiver in accordance with the present invention;

FIG. 6 is a perspective view of another dust collector having an integrated receiver in accordance with the present invention;

FIG. 7 is a perspective view of an alternate remote control embodying features of the present invention;

FIG. 8 is a schematic drawing of the receiver of FIG. 7; and

FIG. 9 is a schematic drawing of the transmitter of FIG. 7.

### DESCRIPTION OF THE PREFERRED EMBODIMENTS

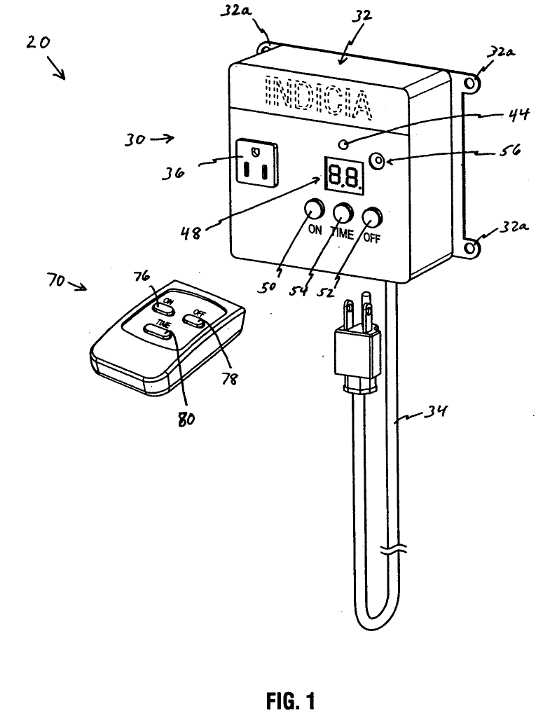

An apparatus for controlling the operation of a dust collector is illustrated in FIG. 1, and is referred to generally by reference numeral 20. The remote control 20 has a receiver 30 and a transmitter 70 for transmitting signals to the receiver 30. The receiver 30 includes a housing 32 in which at least a portion of the receiver electronics are disposed, a power cord 34 for connecting the receiver 30 to a power source, such as a 120V or 240V AC outlet, and an electrical socket 36 for receiving the male connector of a dust collector's power cord.

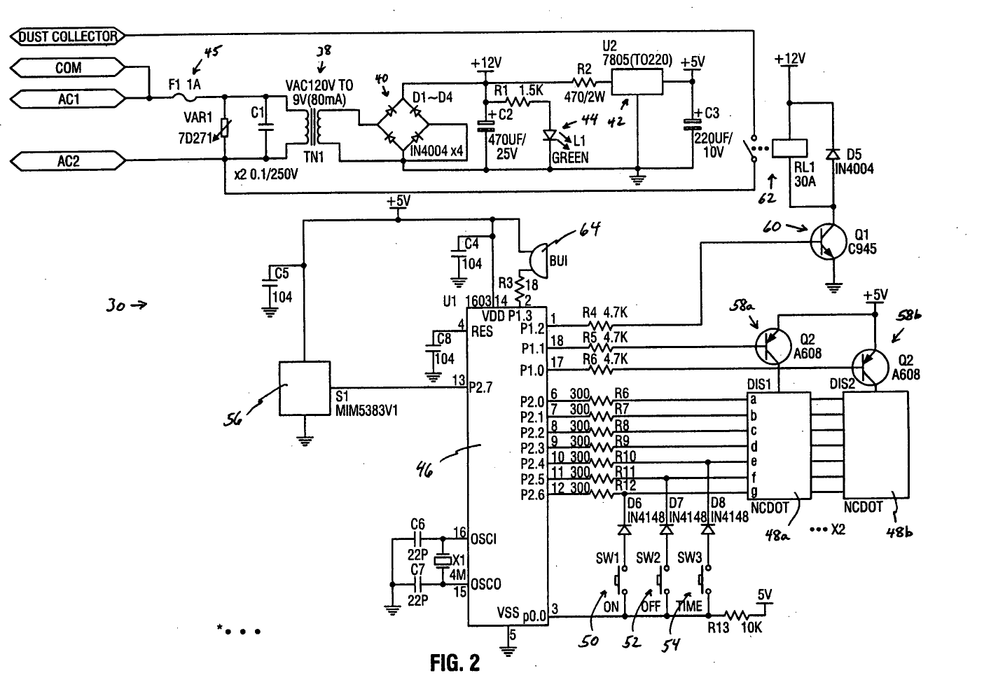

As illustrated in FIG. 2, the power circuitry of the receiver 30 steps the AC power supplied to the receiver 30 from the power cord 34 down via transformer 38 and converts the power to a DC voltage via rectifier 40 which is capable of operating the remainder of the circuitry. More particularly, the AC power is initially stepped down and rectified to 12V DC, and further reduced to 5V DC via voltage regulator 42. A power indicator, such as light emitting diode (LED) indicator 44, is provided to alert an operator when power has been supplied to the receiver 30. If LED 44 is not illuminated when the receiver 30 is plugged into a power supply, the fuse 45 may have been blown to protect the electronics of the receiver 30.

The receiver 30 further includes a controller, such as microcontroller 46, for responding to input signals received by the receiver 30. In the form illustrated, controller 46 is a CP8112B-L8SN24 IC provided by Ceramate Technical Co. Ltd. of Taiwan. The controller 46 is connected to a display, such as digital displays 48a and 48b, and various input switches, such as power ON switch 50, power OFF switch 52, and TIMER switch 54. In addition, the controller 46 is connected to a receiver, such as infrared (IR) receiver 56, for receiving and responding to input signals received from the transmitter 70.

In FIG. 2, the controller 46 is connected to the 5V DC supplied by the power circuitry at pin 14 (VDD), and is connected to ground at pin 5 (VSS). The ON, OFF and TIMER switches, 50, 52 and 54, are normally open and connect pin 3 (P0.0), which is pulled high up to the 5V DC voltage, to bi-directional pins 12 (P2.6), 11 (P2.5) and 10 (P2.4), respectively. Thus, when ON switch 50 is actuated, pin 12 is pulled high indicating to the controller 46 that the receiver has been turned ON. Likewise, when OFF switch 52 is actuated, pin 11 is pulled high thereby indicating to the controller that the receiver has been turned OFF. Similarly, when TIMER switch 54 is actuated, pin 10 is pulled high indicating to the controller 46 that the timer has been activated and/or incremented.

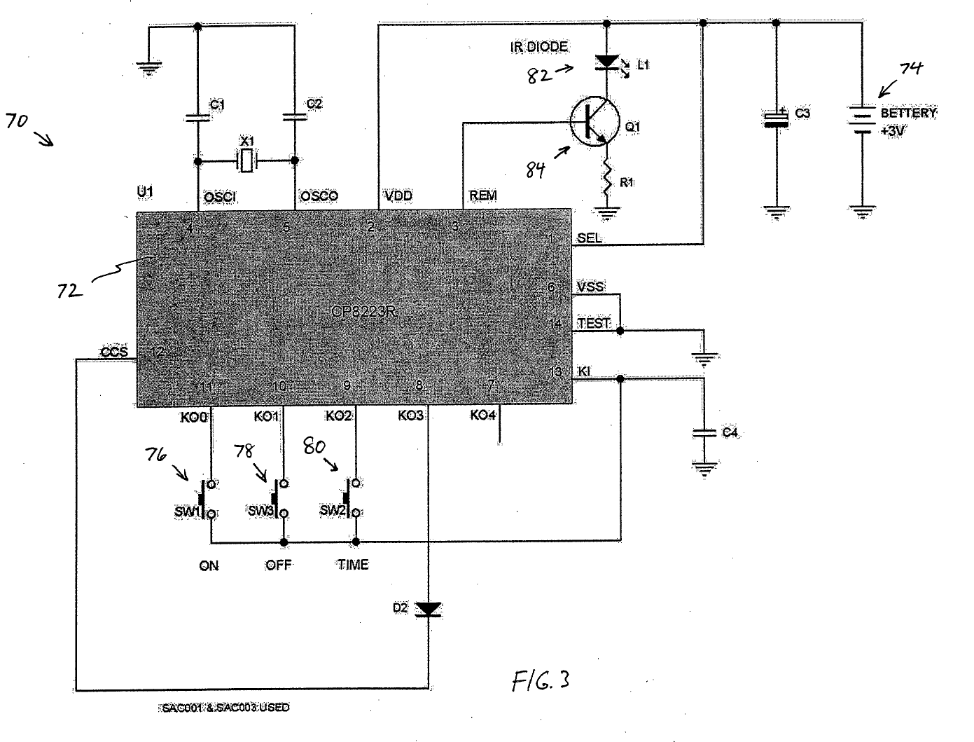

Alternatively, ON, OFF and TIMER inputs may be received from the transmitter 70 to the controller 46 by the IR receiver 56. The IR receiver 56 is connected to pin 13 (P2.7) of controller 46 and to the 5V DC power source and receives incoming signals from the transmitter 70 and inputs this information to the controller 46. The operation of transmitter 70 will be discussed further below with respect to FIG. 3.

Once an ON input has been received, whether it be from the actuation of ON switch 50 or receipt of an ON signal transmission from transmitter 70, the controller 46 turns on transistor 60 which, in turn, powers relay 62 to close its switch, thereby supplying power to socket 36 and the motor of the dust collector connected thereto. Power will continue to be supplied to the socket 36 until an OFF input is received from the controller 46 (e.g., actuation of the OFF switch 52 or receipt of an OFF signal from IR receiver 56), or until the period of time specified via the TIMER input has expired. If the latter has occurred, the controller 46 will actuate buzzer 64 in order to notify the operator that the dust collector has stopped due to an expiration of time set by the TIMER input (e.g., switch 54 or transmitter 70) rather than for some other reason, such as a power failure.

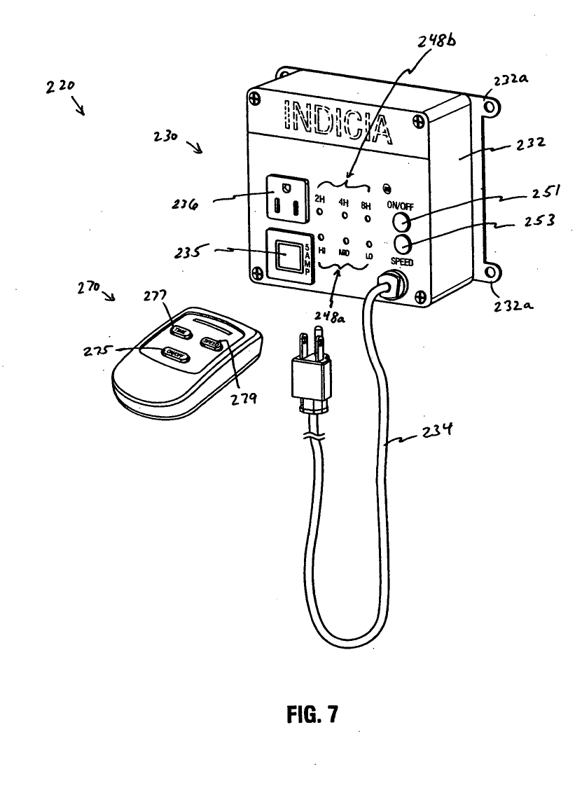

The LED display 48a-b, is connected to the controller 46 at bi-directional pins 6-12, P2.0-2.6, and displays numeric figures corresponding to the data output from these pins. In the form illustrated, controller 46 turns on and off transistors 58a and 58b, connected to pin 18 (P1.1) and pin 17 (P1.0) respectively, in order to turn on and off the displays 48a-b. The numeric output displayed on the displays 48a-b is determined by the data output to pins 6-12 (P2.0-P2.6). In this embodiment, the display 48 is made up of two single digit LED displays 48a-b which are capable of producing a numeric output between 0 and 99. These displays are used to identify the amount of time the dust collector has been programmed to operate for. In alternate embodiments, the controller 46 may be programmed to allow the operator to select from a variety of predetermined time intervals, such as two hours, four hours, eight hours, etc., rather than allowing the operator to select the specific amount of time the dust collector is to run. An example of another type of display that could be used with such as system is illustrated in FIG. 7 and will be discussed further below.

A schematic drawing of the transmitter 70 is illustrated in FIG. 3. The transmitter 70 has a controller, such as ASIC controller 72, which is connected to a battery, such as 3V DC battery 74, at pin 2 (VDD) and ground at pin 6 (VSS). The ON, OFF and TIMER switches, 76, 78 and 80, are normally open and connect pins 11, 10 and 9, respectively, to input pin 13 (KI) so that controller 72 can detect when a switch has been actuated and transmit the corresponding output signal to receiver 30 via IR LED 82. More particularly, when any one of switches 76, 78 or 80 are actuated, the controller 72 determines which switch has been actuated and outputs the corresponding signal by actuating transistor 84 connected to pin 3. In the form illustrated, controller 72 is a CP8223R IC provided by Ceramate Technical Co., Ltd. of Taiwan.

In FIGS. 1-3, the controllers 46 and 72 are microcontrollers, input switches 50, 52, 54, 76, 78 and 80 are momentary on switches, and display 48 is an LED numeric display. It should be understood, however, that in alternate embodiments, different controllers, switches and/or displays may be used to perform the desired functions, generate the desired data and/or display the desired output. For example, in an alternate embodiment a single liquid crystal display (LCD) may be used to produce an alpha/numeric output to indicate day, dates, time (e.g., hours and minutes), etc.

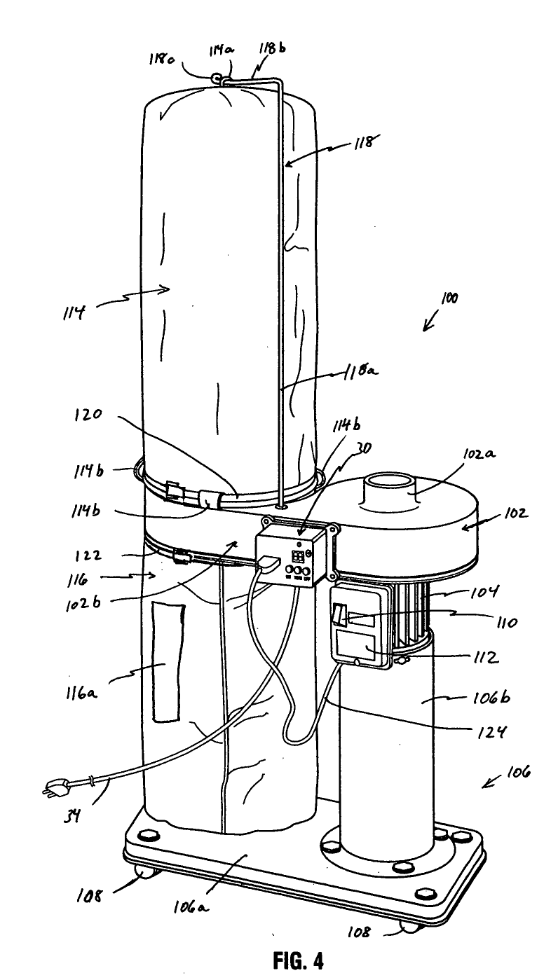

In FIG. 4, the receiver 30 of remote control 20 is shown mounted to a dust collector 100. The receiver 30 may be mounted to the dust collector in a variety of ways and in a number of locations. In the embodiment shown, the receiver housing 32 is mounted to the dust collector 100 via a fastener, such as an adhesive (not shown). The adhesive is applied to the rear of the receiver 30 in the form of a double sided tape and bonds the receiver housing 32 to the exterior surface of the dust collector 100. The receiver housing 32 also includes mounting brackets or bores 32a located on the corners of the receiver which allow the operator to mount the receiver 32 with screws or bolts if desired. The mounting brackets may be used in lieu of or in addition to the adhesive. In alternate embodiments, however, alternate fasteners may be used to fix the receiver 30 to the dust collector 100, such as clasps, hook & loop fasteners, tongue and groove or other mating structures, or the like.

The dust collector 100 has an impeller housing 102 which is connected to a motor housing 104 and a base 106. More particularly, in the embodiment illustrated, the base 106 has a generally rectangular shaped lower base unit 106a from which a support, such as column 106b, extends and upon which the motor housing 104 is mounted. Wheels, such as castors 108, are connected to the lower base unit 106a in order to mobilize the dust collector 100 so that it may be readily moved about a work shop. In a preferred form, conventional locking castors 108 are used so that the dust collector 100 may be secured in place once a desired position has been reached. The castors 108 may be situated at or near the corners of the lower base unit 106a in order to provide easy access for locking and unlocking the castors and in order to provide a well balanced and stable base. In alternate embodiments, however, the dust collector 100 may be provided without wheels or the castors 108 may be removed if such mobility is not desired.

The motor housing 104 is preferably fastened to the base support 106b and the impeller housing 102 via bolts and positions the motor mounted therein such that the output shaft of the motor extends into the impeller housing 102 where it is connected to and drives the impeller. The motor may be any type of motor known in the art, but is preferably an electric motor, such as a totally enclosed fan cooled (TEFC) motor. The size or power of the motor may be selected according to the airflow, velocity, and static pressure required for the dust collector 100. In the embodiment illustrated in FIG. 4, the motor is a one horsepower 115/230V TEFC electrical motor that has a built-in cooling fan connected to the motor output shaft on the side opposite the impeller.

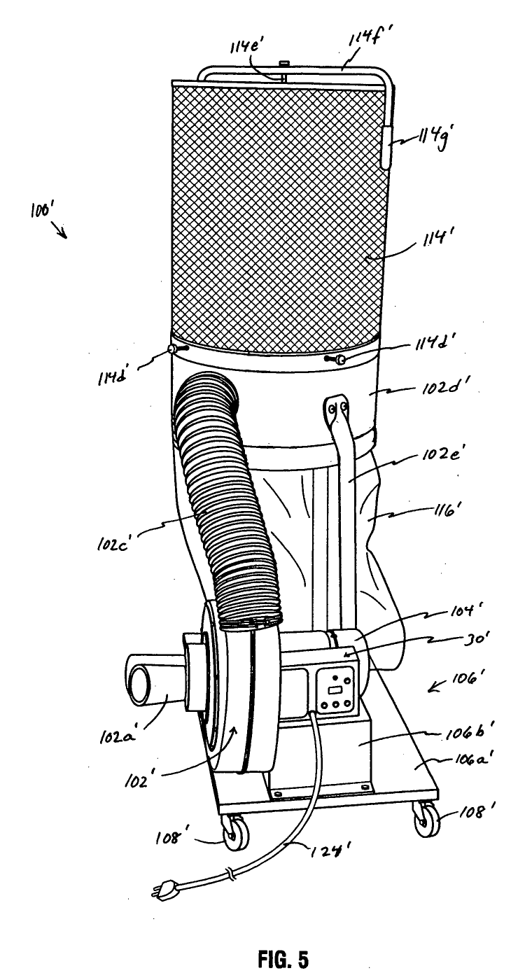

An actuator, such as conventional power switch 110, is connected to the dust collector 100 to allow the apparatus to be turned on and off manually. In the embodiment illustrated, the actuator 110 includes a rocker or paddle switch which extends out from a control panel 112 containing the power circuitry for the dust collector 100. In an alternate embodiment, the control panel 112 may be configured with additional controls for the dust collector 100, such as speed and timer controls, in accordance with the invention disclosed herein. Such an embodiment will be discussed further below with respect to FIGS. 5-9.

The impeller housing 102 forms a conduit through which the dust of the workshop will be drawn and houses the impeller which creates the air flow to draw the dust. In the embodiment illustrated, a conventional blower wheel or rotor impeller is used to create airflow and suction workshop dust in through the intake port 102a of the dust collector 100. The impeller and intake port 102a may take a variety of different sizes depending upon the intended size, speed, and suction capabilities of the dust collector 100. In the illustrated example, the impeller has a diameter of nine and one-half inches and the intake port 102a has a diameter of four inches.

The intake port 102a defined by the impeller housing 102 provides a fitting for receiving a conduit, such as hose, pipe, tube, or other similar components, for connecting the dust collector 100 to a dust collection network or to a particular tool. Although the intake port 102a is illustrated as being located on the top of the impeller housing 102, it should be understood that the port 102a may alternatively be located elsewhere on the impeller housing 102 or the impeller housing itself may be placed in a different position. In addition, the intake port 102a may be provided in a variety of shapes, however, in a preferred form the intake port 102a will be circular in shape to accommodate the industry standard hoses which most tools are designed to work with. In typical applications, the hose will be connected to the intake port 102a via a conventional hose clamp.

The impeller housing 102 further defines an output port 102b through which the workshop dust and air travel. In the form illustrated, the output port 102b forms a large sleeve having a first opening on top to allow the impeller generated airflow to travel out of the impeller housing 102 and through a filter, such as filter bag 114, and a second opening below to allow the dust particles carried by the airflow to fall into a collector, such as collector bag 116.

A filter bag support rod 118 extends up from the impeller housing 102 to hold the filter bag 114 at least generally open. In the embodiment illustrated, the filter bag support rod 118 includes a vertical portion 118a, the end of which is attached to the impeller housing 102, which is sized to allow the filter bag support rod 118 to extend slightly beyond the top of the filter bag 114. The filter bag support rod 118 also includes a horizontal portion 118b attached to the vertical portion 118a. The horizontal portion 118b and vertical portion 118a are preferably formed by an integral bar having a ninety degree (90°) bend or angle, although other bar shapes may also be used. The horizontal portion 118b is sized such that it extends to approximately the center of the filter bag 114 and includes a mating structure, such as hook 118c or other similar structure, which helps secure the filter bag 114 to the filter bag support rod 118 and prevents the filter bag's unintentional removal therefrom. In the form illustrated, the hook 118c of rod 118 mates with at least one hanging strap, such as loop 114a, located at the top of the filter bag 114 to keep the filter bag 114 connected to the support rod 118. In alternate embodiments, these mating structures may take a variety of alternate shapes, (e.g., mating eyelets fastened together via a bolt, etc.).

The hanging strap 114a allows the top of the filter bag 114 to be supported by the filter bag support rod 118 so that the filter operates without obstruction and, preferably, with the maximum amount of filter surface area for the airflow to exit the filter from. In FIG. 4, the hanging strap 114a and mating hook 118c hold the filter bag 114 in a fully extended position which ensures that the maximum amount of filter surface area will be provided to filter the incoming airflow.

A retainer, such as retraining strap 120, secures the bottom, open end of the filter bag 114 to the impeller housing 102. Preferably the output port 102b of the impeller housing 102 includes a lip or fitting to which the bottom of the filter bag 114 may be secured by any conventional retaining strap, such as a strap clamp or the like. In the form illustrated, the retaining strap 120 is fed through alignment structures, such as filter bag loops 114b, which maintain the filter bag's position with respect to the strap to ensure that the filter bag 114 tightly secures the filter bag 114 to the output port 102b of impeller housing 102 so that dust particles within the filter bag 114 cannot escape. This allows the filter bag 114 to filter smaller dust particles out of the air flowing through the dust collector 100 so that these particles are trapped on the interior surface of the filter bag 114 while allowing the filtered air to escape out of the filter bag 114. Eventually the smaller dust particles will settle, along with the larger dust particles, in the collector bag 116.

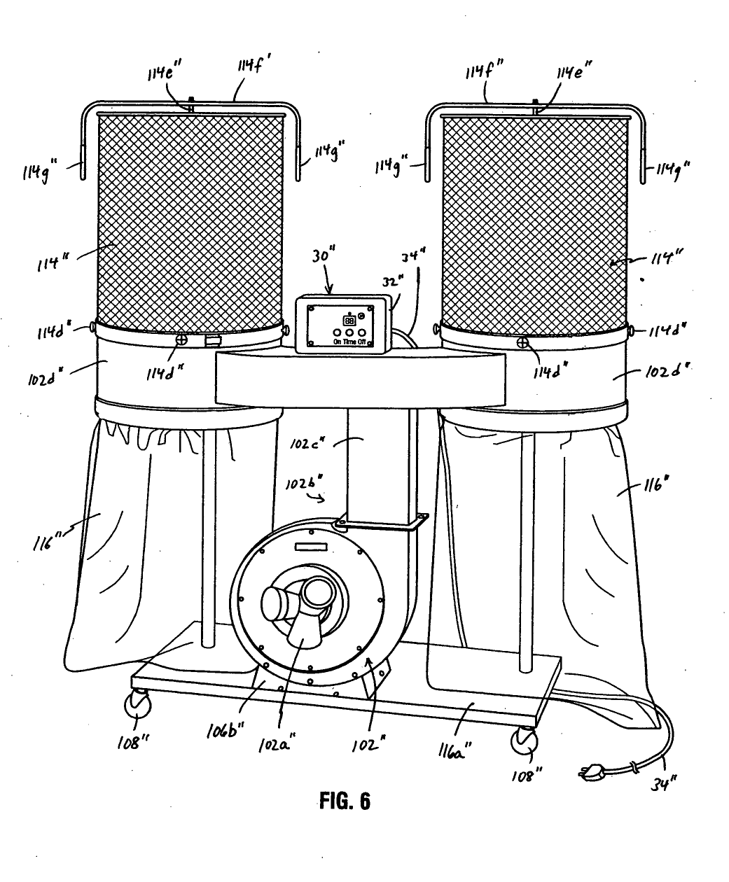

In the embodiment illustrated, the filter bag 114 is made of cloth construction and may be removed from the dust collector 100 to be cleaned and/or washed. The filter bag 114 may have a variety of dimensions, primarily dependent upon the size and speed of the dust collector 100. In the illustrated example the filter bag 114 has a diameter of fourteen inches and a length of thirty-one and one-half inches. As will be discussed in further detail below with respect to FIGS. 5-6, a rigid filter canister may be used in place of a cloth filter bag if desired.

The collector bag 116 is connected to the output port 102b of impeller housing 102 via a retainer, such as retaining strap 122, in a manner similar to that discussed above with respect to filter bag 114. More particularly, the retaining strap 122 tightly secures the collector bag 116 to the lip of output port sleeve, such that dust within the collector bag 116 cannot escape. As dust is blown through the impeller housing 102, gravity forces the larger dust particles downward into the collector bag 116 due to the weight or density of these particles, while the finer particles flow towards the filter bag 114. The finer particles eventually work their way down into the collector bag 116 over time or after the dust collector 100 has been shut off or when the filter 114 is cleaned.

The collector 116 may be constructed of a variety of materials, such as heavy plastic, coated canvas, or any other substantially airtight material, and may be provided in a variety of shapes and sizes depending on the size and speed of the dust collector 100. In the embodiment illustrated, the collector bag 116 is made of coated canvas and has a diameter of fourteen inches, a length of approximately twenty-one and one-half inches, and a capacity of approximately two cubic feet. In alternate embodiments, the collector 116 may be a conventional receptacle, such as a waste container, which allows the operator to simply remove the receptacle form the dust collector 100 and leave it curb-side with other receptacles to be emptied by a waste hauler.

The collector bag 116 may also contain a section which is translucent, such as window 116a, so that an operator may monitor the amount of material within the collector bag 116 to determine when the collector bag needs to be emptied. The window 116a is preferably formed of a transparent flexible plastic which is rectangular in shape and located generally near the upper portion of the collector 116. In this manner, the window 116a will serve as a visible indication of the fullness of the collector 116. In alternate embodiments, a larger portion of the collector 116, or even the entire collector 116, may be made from translucent material. For example, a discardable translucent plastic bag may be provided as the collector 116. Such a bag can simply be removed from the dust collector 100 when full and left along with other waste to be removed by waste haulers. Once removed, the operator can open a new plastic bag and attach it to the output port 102b of the dust collector 100 in the manner discussed above so that the dust collector 100 can again begin to be used to collect more dust particles.

Prior to operating the dust collector 100, a hose will be attached between the power tool being operated and the intake port 102b of impeller housing 102. The receiver 30 of remote control 20 will be mounted to the dust collector 100 via fasteners, such as screws, bolts, adhesive, or the like, and the power cord 122 of the dust collector will be plugged into the mating socket 36 of the receiver 30. As mentioned above, the receiver 30 will preferably be place in a position on the dust collector 100 which keeps the unit up off the floor of the workshop and reduces the number of obstacles between the transmitter 70 and the receiver 30 so that transmissions from the transmitter 70 will be received by the receiver 30. Next, the actuator 110 will be placed in the ON position and the power cord 34 of the receiver 30 will be plugged into an AC power outlet. Once this has been done, the green LED 44 of the receiver 30 will illuminate indicating that the receiver 30 is connected to power.

During operation of the dust collector 100, the operator may turn ON, OFF or adjust the timer of the dust collector 100 via the inputs 50, 52, 54 on the receiver 30 or via the inputs 76, 78 and 80 on the transmitter 70. For example, the operator may turn ON the dust collector 100 and program it to remain on for a period of time while he or she is located in a remote position, such as in front of a power tool that is spaced apart from the dust collector 100. Further, the receiver 30 may be located on the dust collector 100 in a position that may be conveniently reached by the operator, such as knee high or higher on the dust collector so that the operator does not have to significantly bend if he or she wants to manually actuate any of the switches 50, 52 or 54 located on the receiver 30.

FIGS. 5 and 6 illustrate alternate embodiments of dust collectors incorporating features of the present invention. For example, in FIG. 5 an alternate embodiment of a dust collector is illustrated having an integrated or built-in receiver for receiving signals transmitted from the transmitter of remote control. For convenience, features of the alternate embodiment illustrated in FIG. 5 that correspond to features already discussed with respect to the embodiments of FIGS. 1-4 are identified using the same reference numeral in combination with an apostrophe or prime notation (′) merely to distinguish one embodiment from the other, but otherwise such features are similar.

The receiver of the remote control of FIG. 5 (hereinafter referred to as 30′) is built-into the dust collector 100′, and has a receiver housing 32′ with a power cord 34′ extending therefrom. The electronics of the receiver 30′ and transmitter 70′ are identical to those of receiver 30 and transmitter 70 discussed above (see FIGS. 2 and 3), however, the receiver 30′ does not have an electrical socket for receiving the power cord of the dust collector, as illustrated in FIGS. 1 and 4, because the receiver 30′ is not an aftermarket attachment to the dust collector 100′. Rather the receiver 30′ is an integral portion of the dust collector 100′ wherein the receiver 30′ directly controls power to the motor of the dust collector 100′ rather than indirectly through a socket and power cord of the dust collector, as illustrated in FIGS. 1 and 4.

In the embodiment illustrated, the integrated receiver 30′ is connected to the support 106b′ of base 106′ and is electrically wired to the motor contained within the motor housing 104′. Unlike the dust collector 100 discussed above, however, the impeller housing 102′ and motor housing 104′ have been rotated ninety degrees (90°) so that they rest on base 106′ on their side. The impeller housing 102′ continues to be located adjacent the motor housing 104′, but has a Y-shaped intake port 102a′ which allows the dust collector to be connected to two separate dust collection hoses. In addition, the output port 102b′ of impeller housing 102′ is extended via an extension, such as output hose 102c′, which allows the filter 114′ and collector 116′ to be connected to the sleeve 102d′ of the outlet port 102b′ in a manner similar to that discussed above with respect to dust collector 100 (FIG. 4).

More particularly, the output sleeve 102d′ is held in position via supports 102e′ and has a first opening on top to allow the impeller generated airflow to travel out of the impeller housing 102′ and through filter 114′, and a second opening below to allow the dust particles carried by the airflow to fall into collector 116′.

In the embodiment illustrated, dust collector 100′ uses a rigid filter, such as canister filter 114′. The canister filter 114′ has an internal fiber filter surrounded by a metal framework. In a preferred form, the internal fiber filter of the canister comprises a washable pleated filter made from cotton or other fibrous materials. The pleating increases surface area which exposes dust particles to substantially more filter and, in turn, allows the filter to be used for longer periods of time between service intervals. Thus, the filter size, number and depth of pleats all factor into the performance of the dust collector filter. This type of filter design also reduces the amount of disturbance that is made to the airflow through the filter so that the dust collector 100′ can continue to collect dust without sacrificing the amount of air movement through the unit. The metal framework of the canister filter 114′ preferably is cylindrical in shape with a solid metal top and a porous metal side framework.

The canister filter 114′ is secured to and aligned with the upper lip of sleeve 102d′ via fasteners, such as setscrews 114c′, and is self standing so that no additional support or alignment structures are needed. The canister filter 114′ performs the same function as the filter bag 114 (i.e., removes dust from the air which is allowed to flow through the filter canister), but the canister filter 114′ can remove particles as small as two microns, whereas traditional cloth filter bags typically can only remove particles as small as thirty microns. For reference, a human hair is approximately 50 microns in diameter.

Another advantage to the rigid filter 114′ is that it contains an integrated cleaner, such as a sweep, which allows the operator to dislodge dust particles from the internal surface of the filter 114′ so that these particles fall down into the collector 116′. In the form illustrated, the sweep includes a vertical bar 114e′ which extends through the center of the filter 114′ and has at least one flap extending outward from the vertical bar towards the inner surface of the filter 114′. In a preferred form, two flaps extend from opposite sides of the vertical bar 114e′, with one flap extending from the upper half of the vertical bar 114e′ toward the inner surface of the filter 114′ and the other flap extending from the lower half of the vertical bar 114e′ toward the inner surface of the filter 114′. Each flap preferably has a malleable rubber strip on its distal end which makes contact with at least a portion of the inner surface of the filter 114′ to dislodge the particles from the inner surface of the filter when the sweep is actuated.

A handle 114f′ is connected to the portion of the vertical bar 114e′ extending out of the top of the canister filter 114′ and is capable of rotating the sweep to dislodge and drop dust particles from the inner surface of the filter 114′ and into the collector 116′. In the embodiment illustrated, the handle 114f′ is connected to the bar 114e′ via a fastener, such as a screw or bolt. The handle 114f′ extends over the top of the canister filter 114′ and has two gripping portions 114g′ extending down on opposite sides of the canister 114′ which the operator may use to rotate the sweep. Thus, when rotated, the rubber strips of the flaps are dragged over the inner surface of the filter 114′ causing dust particles to be dislodged from the filter 114′ and dropped into the collector 116′.

The pleated filter and integral cleaner improve the amount of air the dust collector 100′ can move through itself per minute (e.g., improve the cubic feet of air movement per minute or CFM) and increase the filtering surface area that the dust collector 100′ is capable of handling. For example, the pleats of filter 114′ reduce the amount of resistant to airflow thereby increasing the CFM of the canister filter 114′ as compared to a traditional filter bag and increase the surface area of the filter 114′ thereby allowing the dust collector to pick up more dust particles.

The collector 116′ of dust collector 100′ includes a retaining ring (not shown) which may be inserted into the lower lip of the output port sleeve 102d′ to secure the collector bag 116′ to the dust collector 100′. For example, in FIG. 5, the open end of the collector bag 116′ is wrapped around a resilient retaining ring which is then either angled or slightly deformed to insert the ring into the lower lip portion of the output port sleeve 102d′. Once released, the retaining ring generally returns to its original shape clamping the open end of the collector bag 116′ between the retaining ring and the lower lip portion of the output port sleeve 102d′. In an alternate embodiment, the ring is simply angled to insert it through the lower opening of sleeve 102d′ and then straightened to clamp the collector 116′ between itself and the lip of the sleeve 102d′.

In a preferred form, the collector bag 116′ will be large enough to rest on the lower base portion 106a′ of the dust collector 100′ so as to prevent the weight of a filled or partially filled collector bag 116′ from causing a rip in the collector bag 116′ or from causing the bag 116′ to unintentionally separate from the output port sleeve 102d′. In the embodiment illustrated, the collector bag 116′ comprises a translucent plastic bag which allows the operator to immediately detect when the bag is full and/or needs replacing.

An alternate embodiment of a dust collector incorporating features of the present invention is illustrated in FIG. 6. In this form, the dust collector includes an integrated receiver located in a different position on the dust collector which is capable of receiving signals transmitted from the transmitter of the remote control. For convenience, features of the embodiment illustrated in FIG. 6 that correspond to features already discussed with respect to the embodiments of FIGS. 1-5 are identified using the same reference numeral in combination with a double prime notation (″) merely to distinguish one embodiment from the other, but otherwise such features are similar.

The receiver of the remote control of FIG. 5 (hereinafter referred to as 30″) is integrated into the dust collector 100″, and has a receiver housing 32″ with a power cord 34″ extending therefrom. The electronics of the receiver 30″ and transmitter 70″ are identical to those of receiver 30′ and transmitter 70′ discussed above with respect to FIG. 5. Meaning, the receiver 30″ does not have an electrical socket for receiving the power cord of the dust collector, as illustrated in FIGS. 1 and 4, because the receiver 30″ is not an aftermarket attachment to the dust collector 100″. Rather the receiver 30″ is an integral portion of the dust collector 100″ which directly controls the power supplied to the motor of the dust collector 100″, rather than indirectly through a socket and power cord of the dust collector, as illustrated in FIGS. 1 and 4.

The dust collector 100″ includes an impeller housing 102″, a motor housing 104″ and a base 106″. Unlike the dust collectors discussed above, however, dust collector 100″ has dual or tandem filters 114″ and collectors 116″ which are connected to the output port 102b″ of impeller housing 102″. More particularly, the output port 102b″ has an extension 102c″ which branches off to separate sleeves 102d″ containing the separate filters 114″ and collectors 116″. The inlet port 102a″ of the impeller housing 102″ provides a triple branch to which three dust collector hoses may be connected. In addition, the dust collector 100″ includes an integrated receiver 30″ which is positioned atop the branching extension 102c″. The receiver's position on the dust collector 100″ makes it convenient for an operator to manually actuate the switches 50″, 52″ and 54″ located on the receiver 30″ without having to bend over, and convenient to receive signals transmitted from transmitter 70″ without interference or obstruction. The transmitter 70″ and receiver 30″ may also be configured to transmit radio frequency (RF) signals rather than infrared (IR) signals in order to prevent such items as walls and doors from interfering with the receiver's ability to receive signals from transmitter 70″.

Another embodiment of a remote control for a dust collector is illustrated in FIGS. 7-9. In this form, the remote includes switches for controlling power, time and speed. For convenience, features of the embodiment illustrated in FIGS. 7-9 that correspond to features already discussed with respect to the embodiments of FIGS. 1-6 are identified using the same reference numeral in combination with the prefix “2” merely to distinguish one embodiment from the other, but otherwise such features are similar.

In the embodiment illustrated, the remote control 220 includes a receiver 230 and transmitter 270. The receiver 230 has a housing 232 with a power cord 234 for connecting the receiver to a power source (e.g., an AC power outlet) and a resettable fuse 235 which protects the electronics of the receiver from damage. Like the receiver of FIG. 1, receiver 230 includes an electrical socket 236 into which the power cord of a dust collector may be plugged so that the remote control 220 may be used to control the function of the dust collector. It should be understood, however, that the remote control 220 may also be provided as an integral part of a dust collector in a manner similar to those discussed above with respect to FIGS. 5 and 6, rather than an aftermarket attachment for a dust collector as illustrated in FIGS. 1 and 7. When supplied as an integrated part of a dust collector, the remote control 220 will be connected directly to the motor of the dust collector rather than indirectly through a socket and power cord.

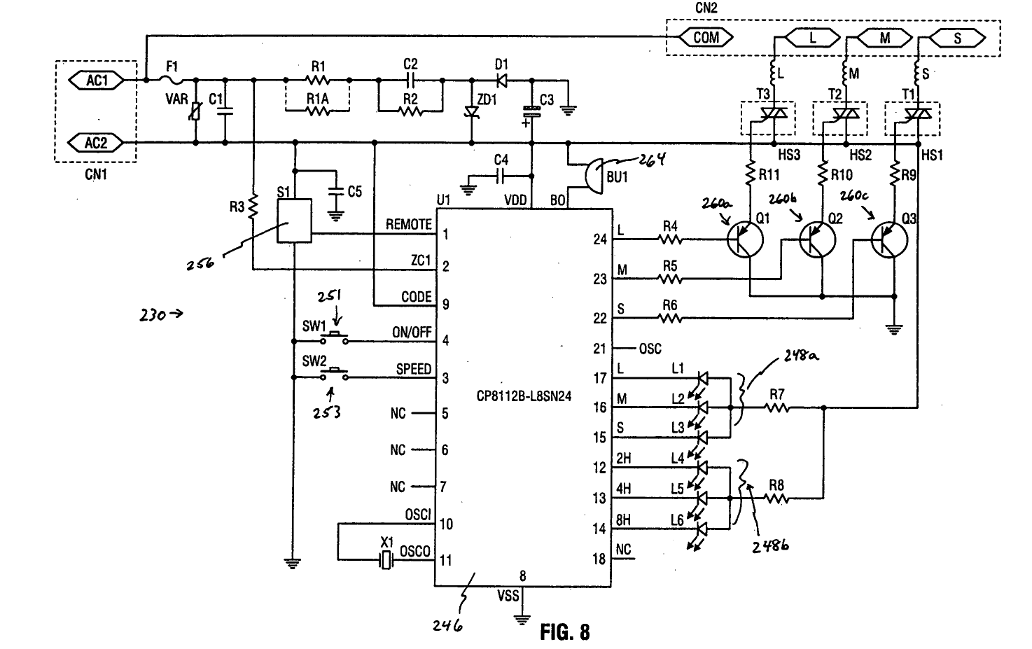

As illustrated in FIG. 8, the receiver 30 includes a controller, such as microcontroller 246, for responding to input signals received by the receiver 230. The controller 246 is connected to a display, such as LEDs 248a and 248b, and various input switches, such as power/time switch 251 and speed switch 253. In addition, the controller 246 is connected to a receiver, such as infrared (IR) receiver 256, for receiving and responding to input signals received from the transmitter 270.

In the embodiment illustrated, the controller 246 is powered through pin 14 (VDD) and grounded through pin 5 (VSS). The power/timer switch 251 and speed switch 253 are normally open and are connected to pins 4 and 3 of controller 246, respectively. When switch 251 of receiver 230 is actuated (e.g., depressed) for the first time or when the power switch 275 of transmitter 270 is actuated for the first time, the controller 246 turns on the dust collector, illuminates the “2H” LED connected to pin 12, and begins a two hour count to keep track of when the dust collector is to be shut off. The “2H” LED is located below the “2H” indicia on the face of receiver housing 232, and the notation “2H” stands for two hour operation. After two hours have passed, the controller 246 will shut off the dust collector and sound buzzer 264 indicating that the time period the timer was set for has expired.

If switch 251 of the receiver 230 or switch 277 of the transmitter 270 are actuated again, the controller 246 turns off the “2H” LED connected to pin 12, turns on the “4H” LED connected to pin 13, and begins a four hour count to keep track of when the dust collector is to be shut off. The “4H” LED is located below the “4H” indicia on the face of receiver housing 232, and the notation “4H” stands for four hour operation. After four hours have passed, the controller 246 will shut off the dust collector and sound buzzer 264 to indicate that the time period the timer was set for has expired.

Similarly, if switches 251 or 277 are actuated again, the controller 246 turns off the “4H” LED connected to pin 13, turns on the “8H” LED connected to pin 14, and begins an eight hour count to keep track of when the dust collector is to be shut off. The “8H” LED is located below the “8H” indicia on the face of receiver housing 232, and the notation “8H” stands for eight hour operation. After eight hours have passed, the controller 246 will shut off the dust collector and sound the buzzer 264 to indicate that the time period set for the timer has expired.

If switches 251 or 275 are actuated again, the controller 246 will turn off the dust collector and any LEDs that have been illuminated to show time or speed. The operator can then turn back on the dust collector or restart this cycle by simply actuating switch 251 or switch 275.

As mentioned above, the remote control 220 also includes a speed switch to control the speed at which the impeller rotates. In the form illustrated, the default speed at which the dust collector starts is low speed. Meaning, when the dust collector is initially turned on, the controller 246 turns on transistor 260a connected to, pin 24, which supplies a low or minimal amount of power to operate the dust collector at low speed, and illuminates the “L” LED connected to pin 17. The “L” LED is located above the “LO” indicia on the face of receiver housing 232, and the notation “LO” stands for low speed.

When switch 251 of the receiver 230 or switch 279 of the transmitter 270 are actuated, the controller 246 turns off transistor 260a and turns on transistor 260b connected to pin 23, which supplies a medium or intermediate amount of power to operate the dust collector at medium speed. The controller 246 also turns off the “L” LED connected to pin 17 and illuminates the “M” LED connected to pin 16. The “M” LED is located above the “MID” indicia on the face of the receiver housing 232, and the notation “MID” stands for mid-level speed.

When switch 251 or switch 279 are actuated again, controller 246 turns off transistor 260b and turns on transistor 260c connected to pin 22, which supplies a high or maximum amount of power to operate the dust collector at high speed. The controller 246 also turns off the “M” LED connected to pin 16 and illuminates the “S” LED connected to pin 22. The “S” LED is located above the “HI” indicia on the face of the receiver housing 232, and the notation “HI” stands for high speed. When switch 251 or switch 279 are actuated again, the controller 246 returns the dust collector to low speed by shutting off the transistor connected to pin 22 and turning on the transistor connected to pin 24. The controller 246 also shuts off the “S” LED connected to pin 15 and illuminates the “L” LED connected to pin 17.

In the embodiment illustrated in FIGS. 7 and 8, the display 248 is made up of two banks of LEDs 248a and 248b. In alternate embodiments, however, the display 248 may include a digital display similar to that of display 48 discussed above or may include another type of display such as a liquid crystal display (LCD) capable of displaying alpha/numeric output that may be used to indicate day, dates, time (e.g., hours and minutes), etc.

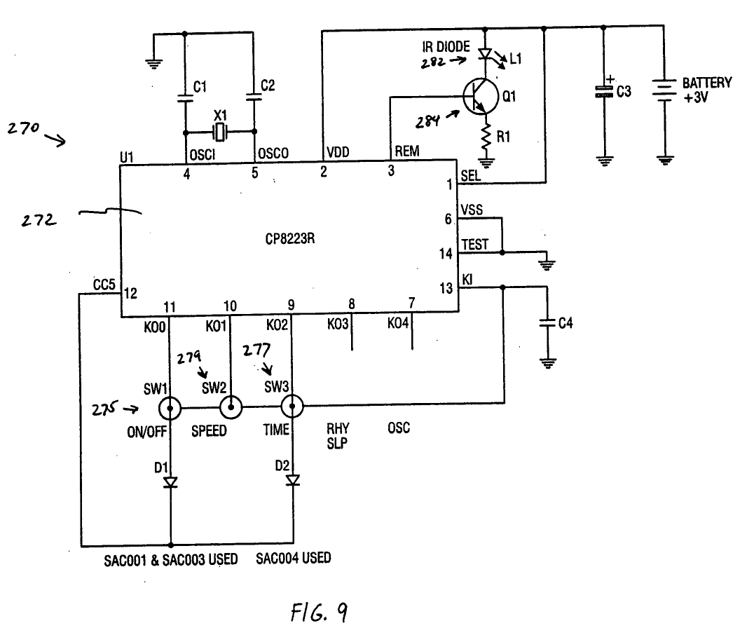

As illustrated in FIG. 9, the circuitry of transmitter 270 is similar to that discussed above with respect to FIG. 3. One difference, however, is that the transmitter 270 is setup with one switch 275 for turning on and off the dust collector through remote control 220, rather than separating the ON and OFF functions over two separate switches as is done in transmitter 70 above. Another difference is that the transmitter 270 includes a speed switch 279 so that the operator may adjust the airflow or suction power of the dust collector.

An operator may want to adjust the dust collector speed for a variety of reasons. For example, an operator may want to adjust the speed of the dust collector depending on the number of tools the dust collector is to collect dust from (e.g., multiple tools may need high speed dust collection whereas a single tool may only need low speed dust collection). Another reason for adjusting the speed of the dust collector may involve the amount of noise desired to be generated from the dust collector (e.g., operation at high speed generates a maximum amount of noise whereas operation at lower speeds generates less noise).

In the form illustrated, the speed may be adjusted from low to medium to high; however, in alternate embodiments, the remote control may provide any number of speeds to choose from or may provide a variable speed input which allows the speed to be adjusted via the clockwise or counterclockwise rotation of a switch. In yet other embodiments of the invention, power and speed may be adjusted through the same switch and time adjusted through a second switch. Thus, an operator would not have to set the time of operation for the dust collector if he or she does not want to. In addition, the operator could adjust the speed by simply actuating the power/speed switch through a cycle similar to that discussed above with respect to the power/timer switch 251.

In still other embodiments, separate switches may be provided for all the controls of the remote 220. For example, one switch may be used for power, another switch for time and another switch for speed. In a preferred form, the switch layout on the transmitter 270 will track that on the receiver 230 (e.g., if there are separate switches for each function on the receiver there will be separate switches for each function on the transmitter), however, this may not be true in alternate embodiments of the invention. For example, the receiver 230 may include a power/timer switch and a speed switch and the transmitter 270 may include separate switches for all three functions, power, timer and speed. Alternatively, the transmitter 270 may be designed with fewer inputs than the receiver 230, if desired.

Lastly, while the dust collectors illustrated and discussed thus far are single-stage dust collectors, other types of dust collectors, such as single bag dust collectors, two-stage dust collectors, and the like may incorporate the present invention as well. Furthermore, it should be understood that various changes in the details, materials, and arrangements of parts and components which have been herein described and illustrated in order to explain the nature of the invention may be made by those skilled in the art within the principle and scope of the invention as expressed in the appended claims. While the present invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

Furthermore, skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common but well-understood elements that are useful or necessary in a commercially feasible embodiment are typically not depicted in order to facilitate a less obstructed view of these various embodiments of the present invention.

1. A remote control for controlling the operation of a dust collector, the remote control comprising:
a transmitter for transmitting signals to control operation of the dust collector;
a receiver for receiving the signals transmitted from the transmitter and controlling the dust collector accordingly; and
a timer connected to at least one of the transmitter and receiver for controlling the operation time for the dust collector.

2. An apparatus according to claim 1 wherein the timer is located at the receiver and includes a plurality of operation time periods for the dust collector.

3. An apparatus according to claim 1 wherein the timer is located at the transmitter and includes a plurality of operation time periods for the dust collector.

4. An apparatus according to claim 1 wherein the timer is capable of being set from a plurality of predetermined operation time intervals for the dust collector.

5. An apparatus according to claim 1 further comprising a display connected to the receiver for indicating the amount of operation time for the dust collector.

6. An apparatus according to claim 1 further comprising a speed control connected to at least one of the transmitter and receiver for setting a speed at which the dust collector operates.

7. A remote control for controlling the operation of a dust collector, the remote control comprising:
a transmitter for transmitting signals to control operation of the dust collector;
a receiver for receiving the signals transmitted from the transmitter and controlling the dust collector accordingly; and
a speed control connected to at least one of the transmitter and receiver for controlling the operational speed for the dust collector.

8. An apparatus according to claim 7 wherein the speed control is located at the receiver and includes a plurality of operational speed settings for the dust collector.

9. An apparatus according to claim 7 wherein the speed control is located on the transmitter and includes a plurality of operational speed settings for the dust collector.

10. An apparatus according to claim 7 wherein the speed control is capable of being set from a plurality of predetermined operational speeds for the dust collector.

11. An apparatus according to claim 7 further comprising a timer connected to at least one of the transmitter and receiver for controlling the operation time for the dust collector.

12. An apparatus according to claim 11 further comprising a display connected to the receiver for indicating the amount of time the dust collector is to operate for.
